(19) United States
(12) Patent Application Publication
(10) Pub. No.: US 2016/0148230 A1
(43) Pub. Date: May 26, 2016

(54) FUEL DISPENSER WITH SURVEY SYSTEM

(71) Applicant: Continental Automotive Systems, Inc., Auburn Hills, MI (US)

(72) Inventors: David Zeiger, Mundelein, IL (US); Brett DeFreese, Palatine, IL (US)

(21) Appl. No.: 14/553,387

(22) Filed: Nov. 25, 2014

(51) Int. Cl. G06Q 30/02; B67D 7/04; G06Q 50/06

(52) U.S. Cl. CPC G06Q 30/0203; G06Q 30/0217; G06Q 50/06; B67D 7/04

(57) ABSTRACT

A fuel dispenser includes a delivery device for delivering fuel to a vehicle. A controller has a memory circuit storing a plurality of survey questions. The controller also has a processing circuit. A display is operated by the processing circuit and is constructed and arranged to display certain of the survey questions to a user of the fuel dispenser. An input, associated with the display, is constructed and arranged to permit the user to reply with answers to the survey questions displayed, with the memory circuit storing the user's answers.

### FIELD

The invention relates to fuel dispensers such as fuel pumps and, more particularly, to a fuel dispenser that incorporates a survey system that enables a user to view and answer marketing questions while at the dispenser.

### BACKGROUND

A driver filling up at a fuel dispensing station such as a gas station is usually waiting for several minutes as the gas tank fills, with the nozzle in the automatic fill mode. Many service stations have added monitors and looped tapes of different forms of entertainment to occupy/attract customers and provide some form of distraction during the wait. These videos may entertain and provide advertising, but they do not obtain any consumer survey data from the user.

Some vendors provide a phone number or website link on the printed transaction receipt, requesting the user to take a survey. However, the user typically ignores the survey request due to the extra steps needed to take the survey.

Thus, there is a need to provide a survey question and answer system directly at a fuel dispenser, enabling direct marketing to the user of the dispenser.

### SUMMARY

An objective of the invention is to fulfill the need referred to above. In accordance with the principles of the present invention, this objective is obtained by providing a fuel dispenser that includes a delivery device for delivering fuel to a vehicle. A controller has a memory circuit storing a plurality of survey questions. The controller also has a processing circuit. A display is operated by the processing circuit and is constructed and arranged to display certain of the survey questions to a user of the fuel dispenser. An input, associated with the display, is constructed and arranged to permit the user to reply with answers to the survey questions displayed, with the memory circuit storing the user's answers.

In accordance with another aspect of an embodiment, a method provides a survey to a user. The method provides a request on a display requesting whether the user wants to conduct a survey. Based on an input provided by the user indicating that the user desires to conduct the survey, questions are provided on the display for the user to answer. Based on inputs provided by the user answering the questions, the user's answers are stored in a database.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawing, wherein like reference numerals refer to like parts, in which:

FIG. 1 is a partial view of a fuel dispenser having a survey system provided in accordance with an embodiment.

FIG. 2 is a schematic illustration of a survey system of the fuel dispenser of FIG. 1.

FIG. 3 is a flow chart showing the steps of a process of an embodiment.

### DETAILED DESCRIPTION OF EXEMPLARY EMBODIMENTS

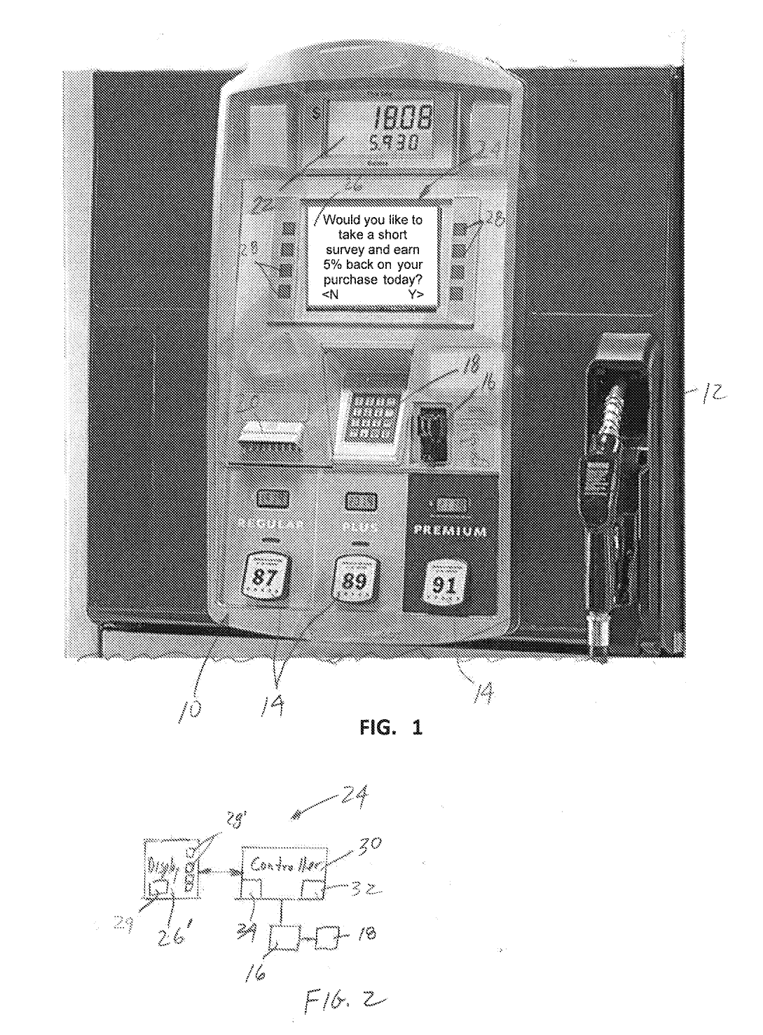

With reference to FIG. 1, a fuel dispenser is shown, generally indicated at 10, in accordance with an embodiment. The fuel dispenser 10 includes the conventional delivery device such a nozzle 12 coupled to a pump (not shown) for dispensing one of types or blends 14 of fuel. As used herein the term “fuel” can include gasoline, ethanol blended gasoline, diesel fuel, LPG, electrical charge, or any other energy source typically used by vehicles and needed to be obtained from a dispenser. For example, if the fuel dispenser 10 delivers electrical charge, instead of a nozzle, the delivery device can be in the form of an electrical connector that can deliver to a rapid re-charge. The dispenser 10 also includes the conventional credit card reader 16, the keypad 18 for entering zip code or the like, the receipt printer 20, and the primary display 22, for displaying the price of the fuel and the number of gallons received.

Consumer survey data is an extremely valuable commodity. Storefronts are constantly asking customers to take an “online” survey with the information given on the receipt. Not all customers take the survey and most simply ignore the information. Since the user of a fuel dispenser may be standing idle next to the dispenser while fuel is being delivered to the vehicle, the user becomes a prime candidate for direct marketing. Thus, in accordance with the embodiment, the dispenser 10 includes survey system, generally indicated at 24, for providing questions and receiving answers from the user of the dispenser 10.

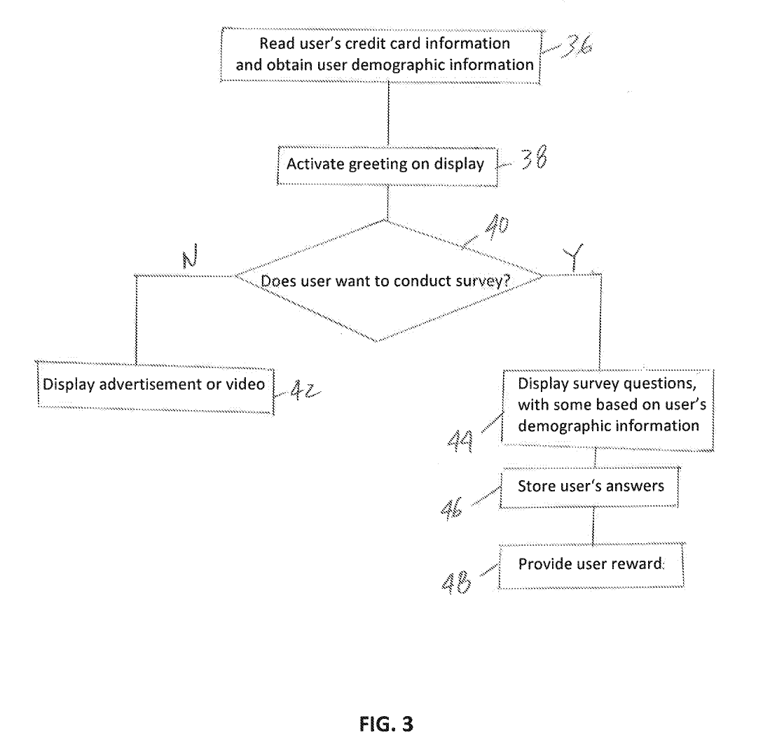

The survey system 24 includes a secondary display 26 that displays information to the user, such as survey questions. The system 24 can include at least one input such as buttons 28, separate from and adjacent to the display 26, permitting the user to respond to questions in a Yes or No manner, or for selecting from a list of answers in and A, B, C, D manner. Alternatively, with reference to FIG. 2, the display 26′ can be of the touch screen type that permits the user to engage a touch-activated portion of the display 26 (e.g. buttons 28′ on the display 26) to provide the answers or to select a touch-screen QWERTY keyboard 29 so as to enter answers to question in a more personal and complete way.

The user is given an option upon the start of fill-up (inserting credit card) whether they would like to answer a few questions. The user can enter Yes or No. If No is entered, the display 26 can display video or other advertisement to the user. If Yes is entered, the survey system 24 can obtain user demographic data that is based on the user's credit card information. This data can be obtained from a controller 30, such as a server, of the system 24. The system 24 has a processor circuit 34 that causes questions, stored in memory circuit 32 of the server 30 and targeted for the user, to be shown on the display 26. Since a user does not want to take too much time on the survey only 4-6 questions can be asked. Some of the questions can request basic demographic information such as age group, car information, etc. A user can always select a “choose not to answer” option. If a user declines to answer many direct demographic questions, the system 24 can “learn” and reduce the number of that type of question asked. The system 24 can still build-up data based on the answers to question, but the demographic data is then built-up into more general questions.

As shown in FIG. 2, the server 30 includes the processor circuit 34 containing the appropriate algorithms for performing the survey process. Based on knowing the user from the credit card information, repeat customers can be sent new questions and surveys upon each visit to the same fueling station. The user inputted answers are stored in the memory circuit 32 of the server 30 for use by the vendor or other marketing firm. The server 30 of can be part of the fuel dispenser 10, can be located at the fueling station, or can communicate with the system 24 remotely, for example, by an internet connection.

To entice users to take the survey at the dispenser 10, if the user conducts the survey, the user can obtain an instant reward, can receive additional reward points (with user's account tracked by the server 30) if the fueling station has a reward program, or a coupon can be dispensed from the printer 20 of fuel dispenser 10. For example, the coupon can be for a free item at the fueling station, or for a discount off the next purchase at the fueling station. The user may obtain rewards based on the number of questions answered such that the more questions answered, the more rewards given.

FIG. 3 shows the steps performed by the algorithm to enable functions of the survey system 24. In step 36, the credit card reader 16 reads the credit card information of the user and the controller 30 obtains user demographic information from the memory circuit 32. In step 38, the processor circuit 34 of the controller 30 causes the display 26 to show the greeting or request on the display 26, asking the user if he or she wants to take a survey. The user provides an input in step 40 as to whether a survey is desired. If no survey is desired, the processor circuit 34 causes the display 26 to show an advertisement or video. If a survey is desired, in step 44, the processor circuit 34 causes the display 26 to show questions (preferably one at a time) on the display 26. Upon the user's input in reply to the question, in step 46, the user's answers are stored in the memory circuit 32 or other database. In step 48, the user may receive rewards for completing the survey.

Thus the system 24 advantageously provides a way to obtain survey information by otherwise idle users at a fuel dispenser.

The operations and algorithms described herein can be implemented as executable code within the controller 30 having processor circuit 34 as described, or stored on a standalone computer or machine readable non-transitory tangible storage medium that are completed based on execution of the code by a processor circuit implemented using one or more integrated circuits. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit and implemented using one or more integrated circuits, where execution of executable code stored in an internal memory circuit causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 32 can be implemented, for example, using a non-volatile memory such as a programmable read only memory (PROM) or an EPROM, and/or a volatile memory such as a DRAM, etc.

Although the system 24 has been described for use at a fueling dispenser, the system is applicable to any Point of Sale (POS) system, such as self check-out systems at stores, for example, grocery or drug stores.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A fuel dispenser comprising:
a delivery device for delivering fuel to a vehicle,
a controller having a memory circuit storing a plurality of survey questions, the controller also having a processing circuit,
a display operated by the processing circuit and constructed and arranged to display certain of the survey questions to a user of the fuel dispenser, and
an input, associated with the display, constructed and arranged to permit the user to reply with an answer to the survey questions displayed, with the memory circuit storing the user's answers.

2. The fuel dispenser of claim 1, further comprising:
a credit card reader for obtaining credit card information of the user,
wherein the memory circuit of the controller stores the credit card information, and
wherein the processor circuit is constructed and arranged to cause the display to display at least one of the survey questions that is based on demographic information of the user obtained from the credit card information.

3. The fuel dispenser of claim 1, wherein the delivery device is a nozzle constructed and arranged to deliver as the fuel, gasoline, a gasoline blend, or diesel to the vehicle.

4. The fuel dispenser of claim 1, wherein the input includes at least one button separate from and adjacent to the display.

5. The fuel dispenser of claim 1, wherein the display is a touch screen display and the input is includes touch-activated portions of the display.

6. The fuel dispenser of claim 1, wherein the controller is a server.

7. A survey system comprising:
a controller having a memory circuit storing a plurality of survey questions, the controller also having a processing circuit,
a display operated by the processing circuit and constructed and arranged to display certain of the survey questions to a user, and
an input, associated with the display, constructed and arranged to permit the user to reply with answers to the survey questions displayed, with the memory circuit storing the user's answers.

8. The system of claim 7, wherein the input includes at least one button separate from and adjacent to the display.

9. The system of claim 7, wherein the display is a touch screen display and the input is includes touch-activated portions of the display.

10. The system of claim 7, wherein the controller is a server.

11. The system of claim 7, in combination with a fuel dispenser adapted to dispense fuel to a vehicle, the system being part of the fuel dispenser.

12. A method of providing a survey to a user, the method comprising the steps of:
providing, by an apparatus, a request on a display requesting whether the user wants to conduct a survey,
based on an input provided by the user indicating that the user desires to conduct the survey, providing, by an apparatus, questions on the display for the user to answer, and
based on inputs provided by the user answering the questions, storing the user's answers in a database.

13. The method of claim 12, wherein the fuel dispenser further includes a credit card reader for obtaining credit card information of the user, the method further comprising:
based on the credit card information, obtaining, with apparatus, demographic information of the user,
wherein the step of providing questions includes:
providing at least one of the questions based on the obtained demographic information.

14. The method of claim 12, further comprising:
providing rewards to the user for conducting the survey.

15. The method of claim 14, wherein the step of providing rewards includes:
causing a printer to print and dispense a coupon.

16. The method of claim 14, wherein the step of providing rewards includes:
adding, by an apparatus, reward points to a user's reward account.

17. The method of claim 12, wherein the display is a display of a fuel dispenser for dispensing fuel to a vehicle, and the input provided by the user is an input to the fuel dispenser.

18. The method of claim 17, further comprising:
providing rewards to the user for conducting the survey.

19. The method of claim 18, wherein the step of providing rewards includes:
causing a printer of the fuel dispenser to print and dispense a coupon.
